(19) United States
(12) Patent Application Publication
(10) Pub. No.: US 2006/0094619 A1
(43) Pub. Date: May 4, 2006

(54) Foamy composition for pretreatment of stains on fabrics

(76) Inventor: John Billman, Scottsdale, AZ (US)

Correspondence Address: SNELL & WILMER;ONE ARIZONA CENTER, 400 EAST VAN BUREN, PHOENIX, AZ, 850040001, US

(21) Appl. No.: 10/978,230

(22) Filed: Oct. 29, 2004

(51) Int. Cl. C11D 17/00

(52) U.S. Cl. 510/284

(57) ABSTRACT

A composition for pretreating stains and/or soils on fabric articles and other launderable textiles before laundering is provided. The composition includes a cleaning component and at least one foaming agent. In addition, the composition optionally includes water, at least one enzyme, and at least one antiredeposition agent.

### FIELD OF INVENTION

The present invention relates generally to compositions for treatment of stains on fabrics before laundering, and more particularly to stain pretreatment compositions that are applied to fabrics as a foam.

### BACKGROUND OF THE INVENTION

Common laundry detergents often are less than completely effective in removing difficult stains from fabrics, such as oily stains (e.g., dirty motor oil, cooking oil, salad dressings, etc.), waxy stains (e.g., lipstick, etc.), particulate stains (e.g., make-up, etc.), and sebum stains, in typical home applications. Pretreatment or spot cleaning of these stains before laundering is often desirable to facilitate removal of the stains before or during laundering. Spot-cleaning of fabrics or other launderable textiles is generally carried out by a two-step process. First, a cleaning composition is applied directly to the stain or soiled area of the fabric article. Second, the fabric article is laundered in a washing machine or subjected to some other mode of cleansing whereby the cleaning composition effects removal of the stain or soil from the fabric article.

Compositions for pretreatment of stains and soils on fabrics before laundering, sometimes referred to as “pre-spotters” or “pretreaters”, are known.

The present invention, as described in greater detail below, in general, provides a novel pretreatment composition, in accordance with its various aspects, that can applied to fabrics as a foam prior to conventional laundering. With the present pretreatment compositions, users may more effectively control placement of the pretreatment composition. Moreover, preferably, visual indicators permit users to observe indicia tending to indicate the pretreatment composition's activity.

### SUMMARY OF THE INVENTION

In accordance with an exemplary embodiment of the present invention, a composition for pretreating stains and/or soils on fabric articles and other launderable textiles before laundering comprises: (i) a cleaning component; (ii) at least one foaming agent; (iii) optionally, water; (iv) optionally, at least one enzyme; and (v) optionally, at least one antiredeposition agent.

In accordance with a further exemplary embodiment of the present invention, a cleaning composition for facilitating at least partial removal of a stain from a fabric article is provided, which comprises: (i) a cleaning component; (ii) at least one foaming agent; (iii) at least one defoaming agent; (iv) at least one solvent comprising glycerin at least in part; (v) optionally, at least one antiredeposition agent; (vi) optionally, at least one liquid carrier; and (vii) optionally, at least one enzyme.

In yet a further embodiment of the present invention, a stain remover for facilitating at least partial removal of a stain from a fabric comprises: (i) a nonionic surfactant blend; (ii) at least one foaming agent; (iii) at least one defoaming agent; and (iv) at least one solvent comprising glycerin at least in part.

### DETAILED DESCRIPTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements without departing from the scope of the invention as set forth in the appended claims.

The pretreatment composition in accordance with various aspects of the present invention, herein referred to as a “stain remover”, relates to the pretreatment of stains and/or soils on fabric articles and other launderable textiles prior to conventional laundering. The stain remover, either alone or in combination with a laundry detergent, enables effective removal of a stain from fabrics before or during laundering. In accordance with various aspects of the present invention, the novel stain remover is formulated as a foam. The term “foam” is used herein to refer broadly to dispersions of gas in liquids. As a foam, the stain remover may be applied substantially uniformly to the stain. In addition, preferably, the stain remover is formulated to remain on the stain without spreading into the fabric surrounding the stain, an area where the cleaner has little value. In addition, preferably the user is instilled with a sense of “control” when applying the stain remover. For example, collapse of the foam preferably enables the product to be more evenly spread across the treated area.

In accordance with one embodiment, a stain remover in accordance with various aspects of the present invention is formulated as a collapsible foam. That is, the foam after application collapses. In this manner, the stain remover is able to penetrate the stain on the fabric article, and thus cleaning efficacy may be enhanced. In addition, the removal of the product and/or other beneficial agents such as by placement into the washer washing them away from the fabric article, for example, when such articles are added to a washing machine, before having a chance to effectively treat the stain.

A stain remover in accordance with various aspects of the present invention generally comprises a cleaning component and at least one foaming agent. In a preferred embodiment of the invention, the cleaning component includes a blend of nonionic surfactants. Suitable nonionic surfactants for use in the nonionic surfactant blend in accordance with one aspect of the present invention include linear primary alcohol ethoxylates. In an exemplary embodiment of the invention, the nonionic surfactant blend of the stain remover may comprise a linear primary alcohol ethoxylate such as L48-3, such as is available as Surfonic 48-3 as manufactured by Huntsman, having an alkyl chain length of C14 to C18 and 3 moles of ethylene oxide. Preferably the L48-3 is present in an amount of about 0 to about 5% be weight of the composition. More preferably, the L48-3 is present in an amount of about 0.5 to about 4.5% by weight of the composition. Optimally, the L48-3 is present in an amount of about 1 to about 4% by weight of the composition.

In another exemplary embodiment, the nonionic surfactant blend may include a linear primary alcohol ethoxylate such as L24-12, such as is available as Surfonic 24-12, as manufactured by Huntsman, having an alkyl chain length of C12 to C14 and 12 moles of ethylene oxide. Preferably the L24-12 is present in an amount of about 0 to about 5% be weight of the composition. More preferably, the L24-12 is present in an amount of about 0.5 to about 4.5% by weight of the composition. Optimally, the L24-12 is present in an amount of about 1 to about 4% by weight of the composition.

A wide variety of LPAE's are manufactured for use in cleaning products, and any now know or hereafter devised LPAE suitable for use in the compositions of the present invention may be used. Preferably, the water soluble EO-hydrophile ranges from about 3 to about 15 EO units, and the alkyl portion comprises on the order of about 6 to about 22 carbons. Other suitable LPAE's may include Surfonic L12-3 to L12-15 and L46-3 to L46-20 (Huntsman), Tomadol 1-3 to 1-9 and Tomadol 25-3 to 25-9 (Tomah), and Biodac 39 to 89 (Sasol/Condea).

In a preferred embodiment of the invention, the nonionic surfactant blend includes a mixture of linear primary alcohol ethoxylates having a range of alkyl chain lengths with a range of moles of ethylene oxide. For example, a suitable nonionic surfactant blend for use in the present invention may include a mixture of L48-3 and L24-12 linear primary alcohol ethoxylates. Nonionic surfactant blends comprising primary alcohols having varying alkyl chain lengths and varying numbers of moles of ethylene oxide groups may increase the efficiency of cleaning while also stabilizing the composition.

In another aspect of an exemplary embodiment of the invention, the nonionic surfactant blend may also comprise iso-branched primary alcohol ethoxylates. In one exemplary embodiment of the invention, a suitable iso-branched primary alcohol ethoxylate may include TDA-3, such as is available as Surfonic TDA-3, as manufactured by Huntsman. The surfactants based upon Iso-branched alcohols are likewise ethoxylated as the linear alcohols above. Among the ethoxylated alcohols, the low wt % TDA-3 combines a strong hydrophobe for efficient cleaning and a low degree of ethoxylation for fluid structure. Isobranched primary alcohol ethoxylates can be effective cleaners for stains such as dirty motor oil stains, greasy stains, which are susceptible to the fluidity of the branched alkyl chains. Further, while not wishing to be bound by any particular theory, it is believed that branched chain lengths disrupt the “packing” of the surfactant into liquid and solid crystals, thus improving stability of the composition. In addition, branched chain lengths tend to be fluid at lower temperatures as compared to linear chain lengths, thus providing cleaning over a broader range of temperatures.

In one exemplary embodiment of the present invention, the TDA-3 preferably is present in an amount of from about 3 to about 7% by weight of the composition. More preferably, the TDA-3 is present in an amount of from about 4 to about 6% by weight of the composition. Optimally, the TDA-3 is present in an amount of from about 4.5 to about 5.5% by weight of the composition.

In yet another exemplary embodiment of the present invention, the TDA-3 preferably is present in an amount of from about 2 to about 6% by weight of the composition. More preferably, the TDA-3 is present in an amount of from about 3 to about 5% by weight of the composition. Optimally, the TDA-3 is present in an amount of from about 3.5 to about 4.5% by weight of the composition. Without being bound to any particular theory, it is thought that by lowering the level of the low EO level materials, along with the amount of any possible defoamer present, the foaming of the formula can increase. For example, using lower levels of TDA-3 enables a Wagon Wheel trigger to produce a stronger foam, generally not found with stain pretreaters in the prior art.

In a preferred embodiment of the present invention, the ratio of L24-12 plus L48-3 to TDA-3 is from about 1:0.75 to about 1:1.5. More preferably, the ratio of L24-12 plus L48-3 to TDA-3 is from about 1:0.9 to about 1:1.4. Optimally, the ratio of L24-12 plus L48-3 to TDA-3 is from about 1:0.9 to about 1:1.3.

In another embodiment of the invention, the cleaning component may comprise any surfactant or surfactant blend that provides a cleaning benefit to the stain remover. For example, it will be appreciated that any suitable anionic, nonionic, ampholytic, zwitterionic, cationic or other surfactant or surfactant mixture may be used. Preferably, the surfactant or surfactant blend is formulated so as to exhibit a cleaning benefit for a variety of stains such as oily stains, waxy stains, sebum stains, protein stains, starchy stains, food stains, and particulate stains.

A stain remover in accordance with various aspects of the present invention also comprises at least one foaming agent. Suitable foaming agents for use in accordance with various embodiments of the stain remover of the present invention include polyglucoside surfactants. One example of a polyglucoside surfactant suitable for use as a foaming agent in the stain remover of the present invention is Plantaren® 2000N manufactured by Henkel KGaA. Other polyglucosides surfactants based upon natural, largely linear, even numbered, alcohols (C8-C16) and where the number of glucoside monomers is on the order of about 1 to about 6 may also be used. For example, various products available from Cognis in wide range of hydrophobes and glucosid-numbers are available, for example, Glucopon™ 225, Glucopon™ 425, Glucopon™ 600, Glucopon™ 625.

In an exemplary embodiment of the present invention, the polyglucoside surfactant is preferably present in an amount of from about I to about 7% by weight of the composition. More preferably, the polyglucoside surfactant is present in an amount of from about 2 to about 6% by weight of the composition. Optimally, the polyglucoside surfactant is present in an amount of from about 3 to about 5% by weight of the composition.

Other suitable foaming agents for use in the stain remover of the present invention include amine oxide surfactants. One example of an amine oxide suitable for use as a foaming agent in the stain remover of the present invention is Schercamox DML, a dimethyl lauryl amine oxide manufactured by Scher Chemicals. Amine oxides of alkyl chain lengths varying from C8 through C14, may be employed.

In an exemplary embodiment of the present invention, Schercamox DML is preferably present in an amount of from about 0 to about 3% by weight of the composition. More preferably, Schercamox DML is present in an amount of from about 0.25 to about 2.75% by weight of the composition. Optimally, Schercamox DML is present in an amount of from about 0.5 to about 2.5% by weight of the composition.

In another embodiment of the invention, the foaming agent may comprise any component that facilitates the creation and/or dispersion of gas into the liquid component of the stain remover. Such foaming agents may facilitate the dispensing of the stain remover as a stable foam by means of, for example, an air-spray foamer, as discussed in more detail hereinbelow. In addition to acting as a foaming agent, certain suitable foaming agents may be effective cleaners of oily, waxy and/or sebum stains, although it will be appreciated that such cleaning benefit is not necessary to the performance as a suitable foaming agent. In addition, certain suitable foaming agents may serve to improve the stability of the stain remover, although, again, such stabilization benefits are not necessary to the performance as a suitable foaming agent.

In accordance with an exemplary aspect of another embodiment of the invention, the stain remover may comprise at least one defoaming agent. Suitable defoaming agents for use in the stain remover of the present invention include silicone-based defoamers, such as polysiloxanes. Examples of suitable defoaming agents for use in the stain remover of the present invention include the silicon emulations—Foamex® A-D 100 manufactured by Rhodia Inc., Dow Corning® Antifoam 1430, and Dow Corning® DSP Antifoam Emulsion. Non-emulsion, particulate defoamers, such as, for example silica and hydrophobically modified silicas, may also be employed. Combination defoamers, such as products combining these modified silica particles with ‘emulsion’ defoamers, may also be used. Examples of combination silicon emulsionslhydrophobically modified silica defoamers include Hi-Mar S-030 and Dow Corning 8010 defoamer.

In an exemplary embodiment of the present invention, the antifoam is preferably present in an amount of from about 0 to about 2% by weight of the composition. More preferably, the antifoam is present in an amount of from about 0.05 to about 1.5% by weight of the composition. Optimally, the antifoam is present in an amount of from about 0.1 to about 1% by weight of the composition.

In yet another embodiment of the present invention, the antifoam is preferably present in an amount of less than about 1% by weight of the composition. More preferably, the antifoam is present in an amount of from about 0.01 to about 0.5% by weight of the composition. Optimally, the antifoam is present in an amount of from about 0.01 to about 0.25% by weight of the composition. Without being bound to any particular theory, it is thought that by lowering of the defoamer, along with level of the low EO level materials, foaming of the formula can increase.

In an aspect of yet another embodiment of the invention, the defoaming agent may comprise any defoaming, antifoaming or other agent that facilitates the collapse of the stain remover foam upon deposition of the stain remover on the fabric article. Preferably, the defoaming agent is dispersible in the stain remover, is stable, and provides effective defoaming when added in relatively small amounts.

In one embodiment of the invention, the collapse of the foam may be gradual. In another embodiment of the invention, the collapse of the foam may occur almost immediately upon deposition of the foam on the fabric, with substantial collapse of the foam after a predetermined period of time. As used herein, “substantial collapse” of the foam means that at least a majority of the bubbles of the foam have broken, thus increasing the fluidity of the stain remover. It is preferable that the foam stain remover of the present invention substantially collapses within a limited amount of time after application on the fabric. More preferably, the foam stain remover substantially collapses within about 10 seconds to about 2 minutes after application to the fabric. Most preferably, the foam stain remover substantially collapses within about 15 to about 60 seconds of application to the fabric.

In a further aspect on an exemplary embodiment of the invention, the stain remover may comprise at least one solvent. One example of a class of solvents suitable for use in the stain remover according to various embodiments of the present invention is glycol ethers, such as Dowanol® DB glycol ether manufactured by Dow Chemical Company. Moreover, in addition to acting as a solvent, Dowanol® DB provides the unexpected result of facilitating thickening of the foam of the stain remover. Another example of a solvent suitable for use in the stain remover of the present invention includes propylene glycol. A wide variety of glycol ethers are available commercially for use in cleaning products.

In an exemplary embodiment of the present invention, Dowanol® DB is preferably present in an amount of from about 0 to about 5% by weight of the composition. More preferably, Dowanol® DB is present in an amount of from about 0.5 to about 4.5% by weight of the composition. Optimally, Dowanol® DB is present in an amount of from about 1 to about 4% by weight of the composition.

In a more preferred embodiment of the present invention glycerin is present in the stain remover. The addition of glycerin to the product assists in keeping the screens in any triggers used in the dispense of the product free from clogs. Without being bound to any particular theory, it is thought that glycerin, a tri-ol and known humectant, holds onto water and can delay the formation of solid phases as it keeps numerous types of materials from drying out. The addition of glycerin aids the product that builds up an a foam-generating screen from drying to a hard, clogging mass. It should be appreciated that any hygroscopic polyol may also be used, including, but not limited to sorbitol and mannitol.

In yet another embodiment of the invention, the stain remover comprises propylene glycol and glycerin in a ratio to facilitate in keeping the foam-generating screen from clogging. In one embodiment of the invention, the propylene glycol and glycerin are present in a ratio within a range of about 3:1 to 1:3. Preferably the propylene glycol and glycerin are present in a ratio within a range of about 1.5:1 to about 1:1.5. Optimally, the propylene glycol and glycerin are present in a ratio on the order of approximately 1:1.

In an exemplary embodiment of the present invention, glycerin is preferably present in an amount of from about 0 to about 5% by weight of the composition. More preferably, glycerin is present in an amount of from about 0.25 to about 4.% by weight of the composition. Optimally, glycerin is present in an amount of from about 0.5 to about 3% by weight of the composition.

In another embodiment of the present invention, the solvent may comprise any suitable solvent that provides a cleansing benefit for oily, waxy, particulate or sebum stains. It is preferable that the solvent have a low volatility and have a molecular weight within the range of from about 100 to about 250. The solvent may be formed of any suitable glycolic, alcoholic or esteric, etheric hydrocarbon.

In yet another embodiment of the invention, the stain remover comprises the defoaming agent(s) and the solvent(s) in a ratio to facilitate the collapse of the foam upon deposition on a fabric article. In one embodiment of the invention, the solvent and defoaming agent are present in a ratio within a range of about 70:1 to 2:1. Preferably, the solvent and defoaming agent are present in a ratio within a range of about 45:1 to about 10:1.

In yet another exemplary embodiment of the present invention, the solvent and defoaming agent are present in a ratio within a range of about 100:1 to 20:1. Preferably, the solvent and defoaming agent are present in a ratio within a range of about 80:1 to about 50:1. Optimally, the solvent and defoaming agent are present in a ratio within a range of about 70:1 to about 60:1.

In another exemplary embodiment, the stain remover may comprise one or more enzymes that provide additional cleaning performance and/or fabric care benefits. A preferred enzyme suitable for use in the stain remover of the present invention includes the protease enzyme, such as that sold under the trademark Savinase® by Novo-Nordisk A/S. Protease provides an effective cleaning benefit for protein-based stains, such as, for example, blood and grass. Another enzyme suitable for use in the stain remover of the present invention is the amylase enzyme, such as that sold under the trademark Duramyle or Termamyl® by Novo-Nordisk A/S. The amylase enzyme may be included to facilitate removal of carbohydrate-based stains, such as those caused by puddings, cooked cereals, starchy foods and the like. Starchy stains can be problematic as they can be invisible until particulates absorb onto them. Other enzymes suitable for use in the stain remover of the present invention include those selected from cellulases, hemicellulases, peroxidases, glucoamylases, lipases, cutinases, pectinases, xylanases, reductases, oxidases, phenoloxidases, lipoxygenases, ligninases, pullulanases, tannases, pentosanases, malanases, glucanases, arabinosidases or mixtures thereof.

In accordance with an aspect of another exemplary embodiment of the invention, a stain remover includes a foam quality agent, such as polyethylene glycol (PEG) 7 glycerol cocoate, sold under the trade name Cetiol® HE by Henkel KGaA. A foam quality agent, such as PEG-7 glycerol cocoate, improves the aesthetic appearance of the foam as it collapses, making the bubbles appear larger and lacier as they collapse. This gives the appearance that the foam is “boiling” or effervescing and, hence, “scrubbing” the stain. Such a feature may enhance the performance impression of the stain remover, as the user may associate the apparent effervescence and/or other activity of the foam with improved cleaning performance. The foam quality agent generally increases the robustness of the film bilayers comprising the foam. While not wanting to be bound by any particular theory, the mechanism by which this is done likely reflects an increase in the rigidity of the bilayer due to the water binding of the glycerol moiety. Thus any other material may also be used for this purpose.

In an exemplary embodiment of the present invention, PEG-7 glycerol cocoate is preferably present in an amount of from about 0 to about 5% by weight of the composition. More preferably, PEG-7 glycerol cocoate is present in an amount of from about 0.25 to about 4% by weight of the composition. Optimally, PEG-7 glycerol cocoate is present in an amount of from about 0.5 to about 3% by weight of the composition.

A stain remover in accordance with the present invention may also include a liquid carrier. Preferably, the liquid carrier comprises water, as water is a readily available, relatively inexpensive liquid carrier. In addition, water may facilitate the cleaning of water-soluble stains. However, other suitable liquid carriers may include Propylene glycol, glycerin or other aforementioned glycol ethers or blends thereof.

A stain remover in accordance with various embodiments of the present invention may also contain other optional ingredients. For example, the stain remover may include one or more antiredeposition agents, such as, maleic acid/acrylic acid polymers, such as, for example, Acusol® 505, 602 445, available from Rohm and Haas Company. Other antiredeposition agents include Acusol® 460, or other now known or hereafter devised antiredeposition agents.

The stain remover also may include one or more preservatives, such as, for example, Dowicil® 75 manufactured by Dow Chemical Company. Moreover, the stain remover may include one or more enzyme stabilizers that stabilize the enzymes in the stain remover. Examples of enzyme stabilizers suitable for use in accordance with various embodiments of the stain remover of the present invention include Na₂B₄O.10H₂O, which facilitates stabilization of the protease enzyme, and CaCl₂.2H₂O, which facilitates stabilization of the amylase enzyme. The stain remover may also include fragrances, dyes, pH adjusting agents, antibacterial agents, and the like.

Exemplary embodiments of the stain remover of the present invention, with each of the components set forth in weight percent, is set forth below in Tables I and II.

TABLE I

| Component | Wt. % |
|---|---|
| Plantaren ® 2000N (50%) | 4.0 |
| Propylene Glycol | 4.0 |
| TDA-3 | 5.1 |
| L48-3 | 1.95 |
| L24-12 | 1.95 |
| Schercamox DML (30%) | 1.0 |
| Dowanol ® DB | 2.4 |
| Cetiol ® HE | 1.0 |
| Water | 73.88 |
| Acusol ® 445 | 0.75 |
| Na₂B₄O₇.10H₂O | 2.0 |
| CaCl₂.2H₂O | 0.03 |
| HCl (18.75%) | 0.94 |
| Dowicil ® 75 | 0.1 |
| Dow Corning ® 1430 | 0.13 |
| Perfume | 0.17 |
| Savinase ® | 0.3 |
| Duramyl ® | 0.3 |
| Total | 100.0 |

TABLE II

| Component | Wt. % | Wt. % | Wt. % |
|---|---|---|---|
| Plantaren ® 2000N (50%) | 4.0 | 4.0 | 4.0 |
| Propylene Glycol | 4.0 | 4.0 | 2.0 |
| TDA-3 | 5.1 | 4.1 | 5.1 |
| L48-3 | 1.95 | 1.95 | 1.95 |
| L24-12 | 1.95 | 1.95 | 1.95 |
| Schercamox DML (30%) | 1.0 | 1.0 | 1.0 |
| Dowanol ® DB | 2.40 | 2.0 | 2.0 |
| Cetiol ® HE | 1.0 | 1.0 | 1.0 |
| Water | Balance | Balance | Balance |
| Glycerin | — | — | 2.0 |
| Boric Acid | 1.34 | 1.34 | 1.34 |
| CaCl₂.2H₂O (35%) | 0.09 | 0.09 | 0.09 |
| Sodium Hydroxide (50%) | 0.73 | 0.73 | 0.73 |
| Dowicil ® 75 | 0.10 | 0.10 | 0.1 |
| Dow Corning ® DSP Antifoam (30%) | 0.40 | 0.09 | 0.20 |
| Fragrance | 0.17 | 0.17 | 0.17 |
| Savinase ® | 0.4 | 0.4 | 0.4 |
| Duramyl ® | 0.2 | 0.2 | 0.2 |
| Total | 100.0 | 100.0 | 100.0 |

A stain remover according to various aspects of the present invention may be prepared by combining the nonionic surfactant blend and the solvents to which the remaining ingredients can be added in any convenient manner.

The stain remover according to various aspects of the present invention may be applied to a fabric article by any suitable method that facilitates application of the stain remover as a foam. One exemplary method of applying the stain remover includes utilizing the Air Spray Foamer Model No. F2 Finger Pump Foamer—1.65 ml, manufactured by AirSpray International. Another exemplary method of applying the stain remover includes utilizing trigger foamers that generate a voluminous, collapsible foam. Exemplary foaming triggers include the Calmar Trigger TS800 with attached screen roamer, Guala's Trigger TS1 V3, L, and Wagon Wheel. It should be noted that some prior art pretreatment compositions suffered from an inability to create any substantial foam with certain triggers. However, the stain pretreatment composition in accordance with the present invention alleviates any such problem. Furthermore, a stain pretreatment composition in accordance with the present invention alleviates problems with clogging in foaming triggers.

It will be appreciated, however, that other methods of applying the stain remover may be employed, such as by utilizing aerosol sprayers, trigger sprayers, pump sprayers or other devices suitable for facilitating application of the stain remover as a foam. Once the foam stain remover is applied to the stained fabric article, it is permitted to remain on the stain until the foam breaks down to a desired extent. At this point, the fabric article can be placed in a washing machine for laundering or, first subjected to mechanical action, such as, for example, rubbing, scrubbing, use of a device (cloth, toothbrush, brush, roller-ball, nubby tip, distil tip) and/or blotting, and then placed in a washing machine for laundering.

Examples 1 and 2 set forth hereinbelow demonstrate the effectiveness of a stain pretreatment composition formulated in accordance with various aspects of present invention in reducing and/or removing various food and non-food stains from fabrics. The performance of a stain remover can be reasonably gauged in terms of its ability to remove consumer relevant stains, that is, stains that are both frequently encountered and are difficult to remove. Primary among the stains with both high frequency and high difficulty to remover are: tomato-based food stains, dirt/clay, oily foods, chocolate foods, blood, grass, makeup, lipstick. Such stains are available from a variety of manufacturers. Stain swatches from three manufacturers are referenced herein: Empirical Manufacturing Company, Cincinnati; Scientific Services, Test Fabrics, PO Box 26, West Pittston, Pa. 18643 USA, and EMPA Testmaterialien, Movenstrasse 12, CH-9015 St. Gallen-Winkeln. The EMPA 102 Stain Monitor cloth includes 15 stains listed in Example 2 applied to 100% cotton knit is referenced below.

Lab-made stains were prepared from 100% Cotton and 50/50 Poly/Cotton Heavyweight t-shirts (Fruit of the Loom). The staining material was applied so as to achieve 2 inch diameter stain. DMO 5 drops, Olive oil 5 drops, Chocolate milk 10 drops ect. With thicker stains, ketchup, spaghetti sauce the stains are applied and distributed evenly over 2-inch spot, by means of a pipette bulb. Lab made stains are prepared and aged for 24 hours before use. Stains are frozen until they are selected for use.

All wash conditions were 20 gallon (large load), medium temperature, single rinse, 7 pounds of ballast (Poly/Cotton pillow cases) and 100 grams of Purex Ultra detergent, 150 PPM hardness. Identical 2002 Kenmore Elite Washers, Heavy Duty, King Size capacity, were used to wash the stains and ballast.

One gram of each stain remover was applied to each stain. The stain remover was spread to cover the stain evenly with a minimum of rubbing. The stain remover was allowed to sit on the stains for 4 minutes prior to being placed into the washing machine. The stain was then evaluated, using conventional techniques, to determine the amount of the stain removed. The assessment of stain removal is made using a portable BYK Hunter Colorimeter Catalog number 6805. The delta E (ΔE) used to characterize the removal of the stains is calculated as the distance, in L*a*b* space, between the color of the unstained cloth and the stained/treated/washed cloth: ΔE=Sqrt((L*₀−L*w)ˆ2+(a*₀−a*_{w})ˆ2+(b*₀−b*_{w})ˆ2 ), where the L* is the lightness, a* measures the red-green, and b* measures the yellow-blue colors. The subscripts are identified as −0 denoting the non-stained fabric and the subscript W corresponds to the stained, treated, and washed stained swatches. This calculated (ΔE) value is a straightforward measure of stain removal, since in the instance of complete stain removal, there would be no difference between the color of the stained and un-stained fabric swatches and AE would equal zero. For incomplete stain removal the stained/treated/washed swatch will be discolored in comparison to the clean cloth and hence positive ΔE would result. The greater the visual difference between the stained/treated/washed swatch and the control un-stained fabric—the greater the ΔE value. For reference, a ΔE of one (1.0) reflects a change in fabric appearance that can be consistently identified by consumers.

### EXAMPLE 1

| STAIN TYPE | ΔE Foam |
|---|---|
| Black Todd Clay (Empirical) | 8.6 |
| Potting Soil (Empirical) | 22.4 |
| Ground in Dirt (Lab) | 13.8 |
| Ketchup on cotton (Lab) | 9.4 |
| Spaghetti on cotton (Lab) | 4.0 |
| Spaghetti on P/C (Lab) | 7.9 |
| Dust Sebum (Scientific Services) | 5.8 |
| Chocolate Milk on cotton (Empirical) | 1.3 |
| Chocolate Milk on Cotton (Lab) | 3.3 |
| Chocolate Milk on P/C (Lab) | 3.9 |
| DMO on P/C (Lab) | 27 |
| OO on P/C (Lab) | 2.6 |
| Mayonnaise on P/C (Lab) | 2.4 |
| Bacon Grease (Lab) | 5.5 |
| Makeup (Empirical) | 22.3 |

### EXAMPLE 2

| STAIN TYPE | ΔE |
|---|---|
| Baby Food | 5 |
| Tea | 17 |
| Spaghetti Sauce | 3 |
| Make-up | 2 |
| Clay | 11 |
| Beta Carrotine | 0 |
| Blood | 2 |
| Curry | 10 |
| Burned Butter | 2 |
| Grass | 4 |
| Chocolate Pudding | 15 |
| Red Wine | 19 |
| Dirty Motor Oil | 17 |
| Animal Fat/Red Dye | 30 |
| Peat | 14 |

Examples 1 and 2 illustrate the strong cleaning performance of the foam product which is shown to be an effective cleaner of a wide variety of stains. It exceeds the performance of a leading commercial spray product on key, high frequency stains, clays and tomato-based sauces and chocolate milk and pudding. It bests the competitive product on difficult but less frequent stains like makeup, curry. On the majority of other stains the foam is a parity to the leading competitive product.

As should now be appreciated, stain pretreatment compositions in accordance with various embodiments of the present invention may be applied to fabrics as a foam. Accordingly, the pretreatment composition provides for residence time of the composition on the stain sufficient for effective removal of at least a portion of the stain upon laundering. Although the compositions of the present invention are primarily designed for use as pretreatment compositions, these compositions can also be used as laundry detergents or cleaning agents.

In the foregoing specification, the invention has been described with reference to specific embodiments. However, one of ordinary skill in the art appreciates that various modifications and changes can be made without departing from the scope of the present invention as set forth in the claims below. Accordingly, the specification is to be regarded in an illustrative rather than a restrictive sense, and all such modifications are intended to be included within the scope of the present invention.

Benefits, other advantages, and solutions to the problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A cleaning composition for facilitating at least partial removal of a stain from a fabric article, comprising:
a cleaning component;
at least one foaming agent;
at least one defoaming agent;
at least one solvent;
glycerin;
optionally, at least one antiredeposition agent;
optionally, at least one liquid; and
optionally, at least one enzyme.

2. The cleaning composition of claim 1, wherein said cleaning component comprises at least two linear primary alcohol ethoxylates.

3. The cleaning composition of claim 1, wherein said cleaning component comprises an iso-branched primary alcohol ethoxylate.

4. The cleaning composition of claim 1, wherein said at least one foaming agent comprises a polyglucoside surfactant.

5. The cleaning composition of claim 1, wherein said at least one foaming agent comprises an amine oxide surfactant.

6. The cleaning composition of claim 1, wherein said at least one defoaming agent is silicone-based.

7. The cleaning composition of claim 1, wherein said at least one solvent comprises glycol ether.

8. The cleaning composition of claim 1, wherein said at least one solvent comprises propylene glycol.

9. The cleaning composition of claim 1, wherein said glycerin and said propylene glycol are present in a ratio from about 3:1 to about 1:3.

10. The cleaning composition of claim 1, wherein said liquid carrier comprises water.

11. The cleaning composition of claim 1, wherein said at least one enzyme comprises at least one of protease, amylase, cellulase, hemicellulase, peroxidase, glucoamylase, lipase, cutinase, pectinase, xylanase, reductase, oxidase, phenoloxidase, lipoxygenase, ligninase, pullulanase, tannase, pentosanase, malanase, glucanase, and arabinosidase.

12. The cleaning composition of claim 1, further comprising PEG-7 glycerol cocoate.

13. The cleaning composition of claim 1, wherein said at least one solvent and at least one defoaming agent are present in a ratio within the range of about 70:1 to about 2:1.

14. A cleaning composition for facilitating at least partial removal of a stain from a fabric article, comprising:
a cleaning component comprising a nonionic surfactant blend;
wherein said nonionic surfactant blend is formed of at least two primary alcohol ethoxylates and an iso-branched primary alcohol ethoxylate, wherein said at least two primary alcohol ethoxylates exhibit at least one of different alkyl chain lengths and different number of moles of ethyl oxide groups;
at least one foaming agent;
at least one defoaming agent; and
at least one solvent.

15. The cleaning composition of claim 14, wherein said at least two primary alcohol ethoxylates and said iso-branched primary alcohol ethoxylate are present in a ratio of about 1:0.75 to about 1:1.5.

16. The cleaning composition of claim 14, wherein said at least one defoaming agent is present in an amount of less than about 1% by weight of the composition.

17. The cleaning composition of claim 14, wherein said at least one foaming agent comprises at least one of a polyglucoside surfactant, an amine oxide surfactant, and combinations thereof.

18. The cleaning composition of claim 14, wherein said at least one solvent comprises at least one of propylene glycol, glycol ether, glycerin, and combinations thereof.
